(19) United States
(12) Patent Application Publication
(10) Pub. No.: US 2012/0022965 A1
(43) Pub. Date: Jan. 26, 2012

(54) GEOLOCATION BASED BIDDING SYSTEM, METHOD AND APPARATUS

(76) Inventor: Michael J. Seergy, Pine Brook, NJ (US)

(21) Appl. No.: 13/252,936

(22) Filed: Oct. 4, 2011

(51) Int. Cl. G06Q 30/06

(52) U.S. Cl. 705/26.4

(57) ABSTRACT

A system, methods, and apparatus for geolocation based bidding are disclosed. In an example embodiment, sales data regarding geolocation availability information and item and/or service information is stored. A consumer may provide a request for a response by inputting machine readable data including an identifier into a mobile device, and the request includes geolocation data of the mobile device. Bids may be requested from sellers determined based on the identifier, the geolocation data, and the sales data. Bids including a price and availability may be received from sellers based on the consumer request. A bid response may be provided to the consumer mobile device with at least one bid that is binding a seller for a period of time.

### CROSS REFERENCE TO RELATED APPLICATIONS

The present application relates to the following pending patent applications: U.S. patent application Ser. No. 13/176,497, filed on Jul. 5, 2011; U.S. patent application Ser. No. 13/176,525, filed on Jul. 5, 2011; and U.S. patent application Ser. No. 13/207,858, filed on Aug. 31, 2011.

### BACKGROUND

Sellers of goods and services may set pricing based on a wide range of factors. Typically, a product or service may have a standard price or price range, but prices for many items or services may be highly flexible. Supply and demand, profit margins, inventory levels, quarterly sales goals, and the like may dictate maintaining prices, raising prices, or reducing prices. For example, the retail industry typically allows retailers to make a significant profit margin on items such as clothing, which may come into fashion or go out of fashion relatively quickly. In many cases, a retailer will have a sale and slash prices on a particular item, which may clear out inventory, provide a short term cash flow, act as a loss leader, bring new consumers to the store, and customer loyalty. Also, for example, retailers may set prices on items to match or undercut a competitor's prices. In many cases, consumers actively compare prices between different retailers, for example, in a shopping mall or on the internet. However, many consumers are not typically comparing prices, especially for items that are not big ticket purchases. For example, in the retail clothing industry, consumers typically purchase an item without checking every possible retailer for a better deal on that item. In many cases, a consumer purchases an item that may be available for a better price at a nearby location, and typically, the consumer would like to have saved money and a retailer with the item priced lower would like to have made a sale. It may be difficult for sellers to determine how many consumers are actively comparing prices and how many are not. Pricing items too high or too low typically involves a risk. On one hand, too many cost conscious shoppers may be driven away by high prices, but conversely, too much money may be lost from shoppers that would have paid higher prices. Further, sellers typically desire to advertise sales and/or everyday low pricing to cost conscious consumers that have an adequate purchasing power and an interest in a product, so that the lower prices may result in paying customers, and particularly, in the acquisition of new customers. For example, many retailers utilize business intelligence software that collects and analyzes information on their customers and retail consumer behavior in an effort to make improved business decisions relating to pricing, sales, and marketing, and for maintaining existing customers and creating new customers.

### SUMMARY

The present disclosure provides a new and innovative system, methods, and apparatus for geolocation based live bidding. In an example embodiment, sales data regarding geolocation availability information and item and/or service information is stored. A consumer may provide a request for a response by inputting machine readable data including an identifier into a mobile device, and the request includes geolocation data of the mobile device. Bids may be requested from sellers determined based on the identifier, the geolocation data, and the sales data. Bids including a price and availability may be received from sellers based on the consumer request. A bid response may be provided to the consumer mobile device with at least one bid that is binding a seller for a period of time.

Additional features and advantages of the disclosed system, methods, and apparatus are described in, and will be apparent from, the following Detailed Description and the Figures.

### BRIEF DESCRIPTION OF THE FIGURES

FIG. 1 is a high level block diagram of an example network communicating system, according to an example embodiment of the present invention.

FIG. 2 is a detailed block diagram showing an example of a computing device, according to an example embodiment of the present invention.

FIG. 3 is a block diagram showing an example geolocation based bidding network structure, according to an example embodiment of the present invention.

FIG. 4 includes a flowchart illustrating an example process for geolocation based bidding, according to an example embodiment of the present invention.

FIG. 5 is a block diagram showing an example data architecture, according to an example embodiment of the present invention.

FIG. 6 is flow diagram illustrating an example process for geolocation based bidding, according to an example embodiment of the present invention.

### DETAILED DESCRIPTION OF EXAMPLE EMBODIMENTS

The present disclosure relates in general to a system for providing a channel of commerce and, in particular, to geolocation based bidding. Briefly, in an example embodiment, a system is provided which allows a consumer shopping at a mall, in a retail clothing store, to request bids for a retail item, such as a sweater. For example, a consumer may use a mobile device to take a picture of a universal product code (“UPC”) or a stock keeping unit (“SKU”) of the sweater from a display shelf or a price tag. The specific sweater may be identified by decoding a barcode or data matrix, and/or by optical character recognition of written text. By taking a picture of this data which identifies the particular sweater the consumer wants to buy, a request for bids may be sent to retailers which may be able to provide the same sweater or a comparable sweater. Retailers may then provide bids to sell the retail item, including for example, a lower price and confirmation of availability of an item at a nearby location. Retailer bids may be provided in real-time for identical items and/or comparable items, including intrabrand bids and interbrand bids. A bid response sent to the consumer may include one or more bids, as well as additional information, such as suggested retail price and recent sales prices of the item. For example, the consumer may select a retailer bid to purchase an identical sweater based on the prices and availability and/or delivery options available in the bid response. In an example embodiment, a consumer may provide a bid acceptance via the mobile device, for example, with an electronic signature authorizing a credit card payment. Also, for example, a consumer may provide terms for automatic bid acceptance, which if met by a seller's bid, the consumer may be automatically bound to the purchase. Further, the presently disclosed system may allow for inventoryless bidding by retailers. For example, a retailer that does not have an item in its in-store inventory in a specific nearby store can still make a bid to sell that item, and deliver an item to the consumer directly from a distributor or manufacturer. The present system may advantageously allow sellers to make geolocation based bids to consumers to capitalize on the knowledge of a consumer's current purchase intent while adapting to the sales market in real-time. In a non-limiting example embodiment, certain features disclosed in the present patent application may be commercially embodied in products and services offered by Coventry Holdings LLC, the assignee of the present application.

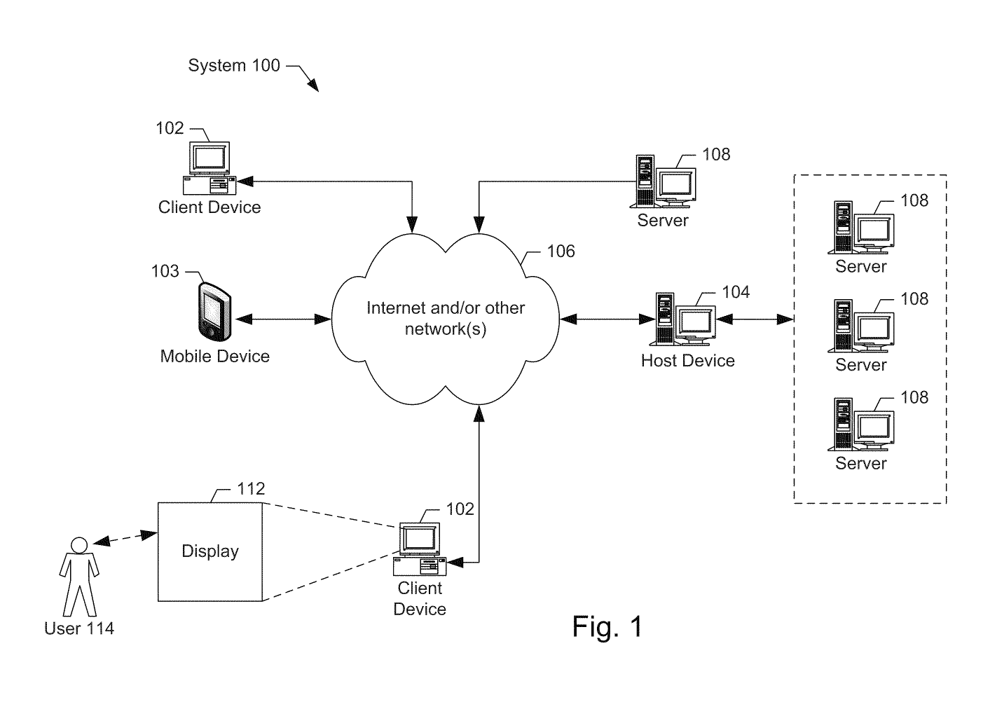

The present system may be readily realized in a network communications system. A high level block diagram of an example network communications system 100 is illustrated in FIG. 1. The illustrated system 100 includes one or more client devices 102, and one or more host devices 104. The system 100 may include a variety of client devices 102, such as desktop computers and the like, which typically include a display 112, which is a user display for providing information to users 114, and various interface elements as will be discussed in further detail below. A client device 102 may be a mobile device 103, which may be a cellular phone, a personal digital assistant, a laptop computer, a tablet computer, etc. The client devices 102 may communicate with the host device 104 via a connection to one or more communications channels 106 such as the Internet or some other data network, including, but not limited to, any suitable wide area network or local area network. It should be appreciated that any of the devices described herein may be directly connected to each other instead of over a network. Typically, one or more servers 108 may be part of the network communications system 100, and may communicate with host servers 104 and client devices 102.

One host device 104 may interact with a large number of users 114 at a plurality of different client devices 102. Accordingly, each host device 104 is typically a high end computer with a large storage capacity, one or more fast microprocessors, and one or more high speed network connections. Conversely, relative to a typical host device 104, each client device 102 typically includes less storage capacity, a single microprocessor, and a single network connection. It should be appreciated that a user 114 as described herein may include any person or entity which uses the presently disclosed system and may include a wide variety of parties. For example, as will be discussed in further detail below, users 114 of the presently disclosed system may typically include consumers and/or retailers.

Typically, host devices 104 and servers 108 store one or more of a plurality of files, programs, databases, and/or web pages in one or more memories for use by the client devices 102, and/or other host devices 104 or servers 108. A host device 104 or server 108 may be configured according to its particular operating system, applications, memory, hardware, etc., and may provide various options for managing the execution of the programs and applications, as well as various administrative tasks. A host device 104 or server may interact via one or more networks with one or more other host devices 104 or servers 108, which may be operated independently. For example, host devices 104 and servers 108 operated by a separate and distinct entities may interact together according to some agreed upon protocol.

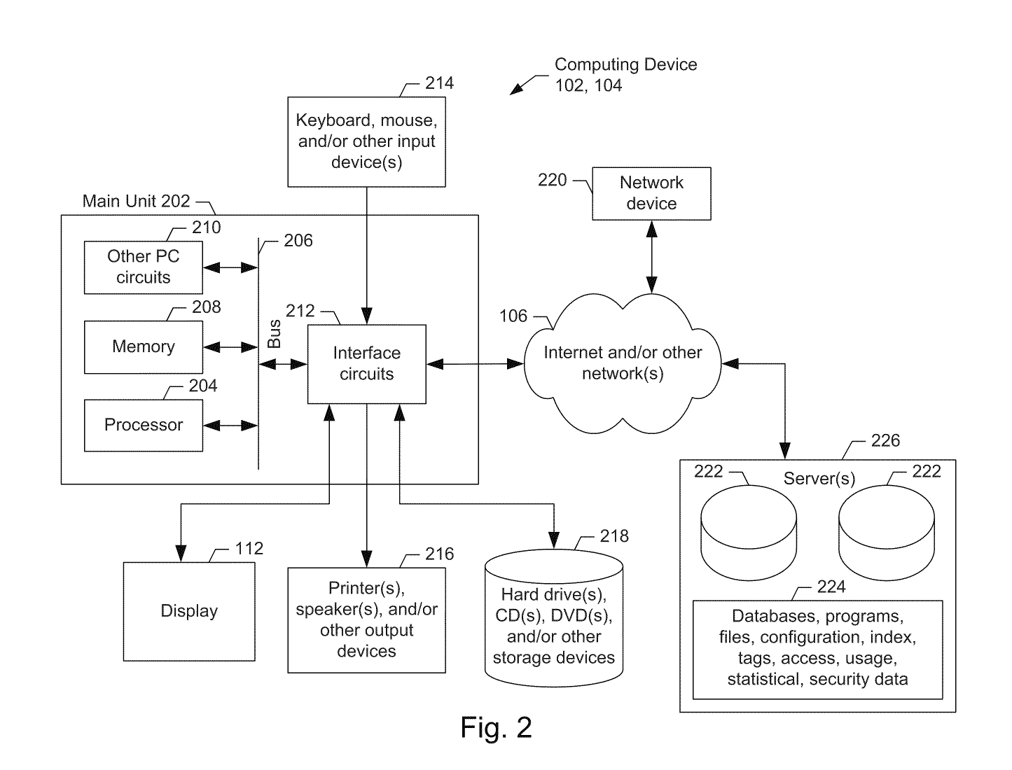

A detailed block diagram of the electrical systems of an example computing device (e.g., a client device 102, a host device 104) is illustrated in FIG. 2. In this example, the computing device 102, 104 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with the other devices in the system 100 as described below. This program may be executed by the processor 204 in any suitable manner. In an example embodiment, memory 208 may be part of a “cloud” such that cloud computing may be utilized by a computing devices 102, 104. The memory 208 may also store digital data indicative of documents, files, programs, web pages, etc. retrieved from a computing device 102, 104 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, image sensor, character recognition, barcode scanner, microphone, and/or a speech or voice recognition system.

One or more displays 112, printers, speakers, and/or other output devices 216 may also be connected to the main unit 202 via the interface circuit 212. The display 112 may be a cathode ray tube (CRTs), a liquid crystal display (LCD), or any other type of display. The display 112 generates visual displays generated during operation of the computing device 102, 104. For example, the display 112 may provide a user interface, which will be described in further detail below, and may display one or more web pages received from a computing device 102, 104. A user interface may include prompts for human input from a user 114 including links, buttons, tabs, checkboxes, thumbnails, text fields, drop down boxes, etc., and may provide various outputs in response to the user inputs, such as text, still images, videos, audio, and animations.

One or more storage devices 218 may also be connected to the main unit 202 via the interface circuit 212. For example, a hard drive, CD drive, DVD drive, and/or other storage devices may be connected to the main unit 202. The storage devices 218 may store any type of data, such as pricing data, transaction data, operations data, inventory data, commission data, manufacturing data, marketing data, distribution data, consumer data, mapping data, image data, video data, audio data, tagging data, historical access or usage data, statistical data, security data, etc., which may be used by the computing device 102, 104.

The computing device 102, 104 may also exchange data with other network devices 220 via a connection to the network 106. Network devices 220 may include one or more servers 226, which may be used to store certain types of data, and particularly large volumes of data which may be stored in one or more data repository 222. A server 226 may include any kind of data 224 including databases, programs, files, libraries, pricing data, transaction data, operations data, inventory data, commission data, manufacturing data, marketing data, distribution data, consumer data, mapping data, configuration data, index or tagging data, historical access or usage data, statistical data, security data, etc. A server 226 may store and operate various applications relating to receiving, transmitting, processing, and storing the large volumes of data. It should be appreciated that various configurations of one or more servers 226 may be used to support and maintain the system 100. For example, servers 226 may be operated by various different entities, including sellers, retailers, manufacturers, distributors, service providers, marketers, information services, etc. Also, certain data may be stored in a client device 102 which is also stored on the server 226, either temporarily or permanently, for example in memory 208 or storage device 218. The network connection may be any type of network connection, such as an Ethernet connection, digital subscriber line (DSL), telephone line, coaxial cable, wireless connection, etc.

Access to a computing device 102, 104 can be controlled by appropriate security software or security measures. An individual users' 114 access can be defined by the computing device 102, 104 and limited to certain data and/or actions. Accordingly, users 114 of the system 100 may be required to register with one or more computing devices 102, 104. For example, registered users 114 may be able to request or manipulate data, such as submitting requests for bids, geolocation confirmations, bid acceptance, and/or terms for automatic bid acceptance.

As noted previously, various options for managing data located within the computing device 102, 104 and/or in a server 226 may be implemented. A management system may manage security of data and accomplish various tasks such as facilitating a data backup process. A management system may be implemented in a client 102, a host device 104, and a server 226. The management system may update, store, and back up data locally and/or remotely. A management system may remotely store data using any suitable method of data transmission, such as via the Internet and/or other networks 106.

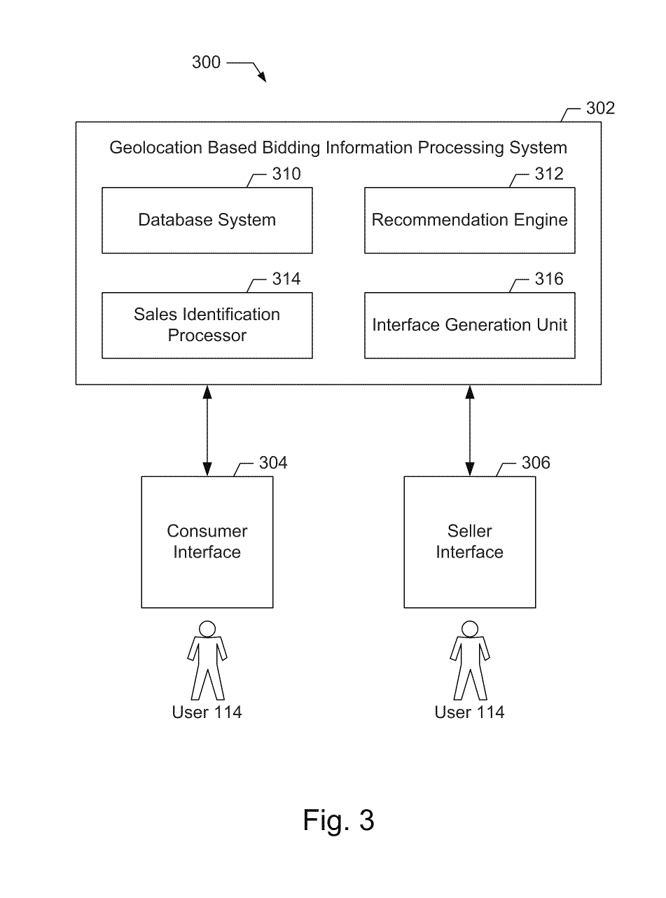

FIG. 3 is a block diagram showing an example geolocation based bidding network structure 300 which includes a geolocation based bidding information processing system 302, a consumer interface 304, and a seller interface 306. The example geolocation based bidding information processing system 302 may be implemented on one or more host devices 104 accessing one or more servers 108, 226. In an example embodiment, the geolocation based bidding information processing system 302 includes a database system 310, a recommendation engine 312, a sales identification processor 314, and an interface generation unit 316. A user 114 may be a consumer that interacts with the consumer interface 304 or a seller that interacts with the seller interface 306. A database system 310 may include a wide variety of data used by the geolocation based bidding information processing system 302, including sales identification data, geolocation data, seller data, consumer data, and the like, which may generally be referred to as sales data, or in the retail context, retail data. A recommendation engine 312 may provide recommendations for sellers and consumers. A sales identification processor 314 may be used for identifying specific goods or services requested, such as retail items based on a picture of an item UPC or SKU. Interface generation unit 316 may provide, for example, HTML files which are used at the consumer interface 304 and seller interface 306 to provide information to the users 114. It should be appreciated that he the consumer interface 304 and the seller interface 306 may be considered to be part of the geolocation based bidding information processing system 302, however, for discussion purposes, the consumer interface 304 and the seller interface 306 may be referred to as separate from the geolocation based bidding information processing system 302.

In an example embodiment, a user 114 may interact with a consumer interface 304 to determine if a retail item of interest is a good deal and/or if a better deal may be available. For example, a consumer may be shopping in a retail store in a mall, and interested in purchasing a specific sweater, such as a red cashmere v-neck four-button cardigan. The consumer may take a picture of the UPC of the sweater to request bids from retailers using the consumer interface 304 (e.g., user opens geolocation based bidding application on mobile device, takes a picture of the sweater's price tag, and presses enter). The consumer may also interact with the consumer interface 304 by inputting required and/or desired sale terms, such as price, location range, sale time frame, etc. The price of the sweater may be input by hand if not captured in the identifying data such as a UPC, so that competing retailers may submit bids accordingly. The consumer interface 304 may provide a wide variety of features and specifications which the consumer may choose from in providing a request. Based on the information put into the consumer interface 304 from the consumer, as well as information received from sellers, the consumer interface 304 may provide a response including one or more bids or offers, reports, recommendations, and/or navigational information to the consumer. As will be discussed in further detail below, the information provided by the consumer interface 304 may include current or recent prices for comparable retail items, such as similar sweaters. The geolocation based bidding information processing system 302 may process data received by the consumer interface 304, as well as the seller interface 306, to respond to a request from a consumer. For example, data from database system 310 may be used to create a bid, queried for use in a report, or a recommendation may be provided by recommendation engine 312 according to the consumer request and current sales market data. Further, as discussed below, a seller, such as a retailer of a comparable sweater may participate in real-time, by providing live bids in response to the consumer request for bids. Bids may be provided for in-store items at nearby locations and/or for delivery at the consumer's home within a time frame such as one day or two day shipping.

In an example embodiment, the consumer may set requirements in the consumer interface 304 for a request. For example, the consumer may require that only exact product matches be provided, so that bids for comparable items that are not made by the same manufacturer, with all the same features, will not be provided in the bid response to the consumer. Similarly, the consumer may specify certain features of comparable items, such as general flexibility on brand, style, color, or may provide a specific list of brands, styles, or colors. Also, for example, the consumer may need the item the same day, in which case, a delivery of the item is not feasible and the consumer may only be willing to travel within ten miles. Accordingly, the consumer may set a location range of ten miles and disallow delivery bids. Similarly, if the consumer needs the item by the next day, the user may allow for in-store bids as well as home delivery bids within 24 hours. Also, for example, the consumer may set a bid price requirement, so that only prices lower than the item the consumer already has are provided in the bid response. Similarly, the consumer may require that bid prices be $5 lower, or $20 lower, or some minimum difference to be provided to the consumer interface 304. For example, a consumer may require that bids to sell a sweater must have a price at or below a specific dollar amount, a certain percentage lower than the sweater's offered price, a percentage off of the suggested retail price, or the like. If the consumer provides such requirements, bids not meeting these requirements may not be provided to the consumer. For example, the consumer may take a picture of a bottle of perfume, which is on sale for $59. The consumer may require that bids must provide a discount of at least 20% off the $59 sale price, or that bids must be lower than $40, or that any bid below $59 may be provided. In an example embodiment, a consumer may allow bids for comparable items that are more expensive to be provided. For example, a bid for $65 for a comparable perfume from a top brand name may be provided, and may normally be priced much higher, and provided at a greater discount at $65.

The consumer's mobile device 103 may include a GPS system which provides geolocation data to the consumer interface 304 that is used for making a request for bids from sellers. Accordingly, for example, the sellers receiving bid requests may know exactly where the consumer is, and thus, may be able to make bids that will be enticing enough to bring the consumer to their store. It should be appreciated that a variety of technologies may be used to provide a geolocation of a consumer's mobile device, including for example, a GPS system, an IP address, a MAC address, WiFi connection, a Bluetooth connection, RFID data, etc. Further, the consumer may verify or confirm a location, for example, by entering or selecting a store name, a street address, a mall name, shopping district, etc. Also, for example, a consumer may take a picture of a store logo or a mall logo, which may be processed to confirm a geolocation. Further, in an example embodiment, a user may use a stationary device with a static geolocation, such as a computer at a product display, which is provided in a store to allow consumers to check prices with the geolocation based bidding information processing system 302. For example, for certain products a retailer may be confident that they will have the lowest prices, and may use the geolocation based bidding information processing system 302 as a marketing tool to create customer loyalty.

The user's geolocation is used by the geolocation based bidding information processing system 302 to provide bid request to sellers, as well as the bid response to consumers. For example, if the consumer is in a mall, bids for items within the mall may be provided in a bid response as top choices. The bids from various sellers may be organized by the consumer interface 304 in a way to help the consumer determine the best option based on price, location, and other factors, and supplemental information relevant to the consumer's choice may be provided as well. For example, the interface generation unit 316 may provide summaries of the bids, various additional ratings, reviews, or popularity information, any relevant special offers, etc. The interface generation unit 316 may organize bids based on rankings including best price, nearest location, earliest delivery, a normalized quality index or value index, etc., or some combination of these features. For example, the lowest bid price at a relatively distant location to the consumer may be ranked lower than a slightly higher bid price at a much nearer location. Similarly, a very near location may be ranked lower than a slightly further location with a slightly better bid price. In an example embodiment, the interface generation unit 316 may allow the consumer interface 304 to sort seller bids by a variety of different terms, including price, location, and delivery time. The consumer may be able to toggle between different viewing options for seller bids.

It should be appreciated that in some cases, a particular consumer's request may not return any bids, for example, if the item requested is an uncommon or a unique item without many sellers and/or if the current price is already very low. Also, the recommendation engine 312 may provide recommendations to a consumer based on current and/or recent sales data stored in the geolocation based bidding information processing system 302. For example, if only one or two seller bids are received, the recommendation engine 312 may recommend that a consumer should wait for a better bid because the bids provided are not competitive offers based on recent sales data stored in the database system 310. Accordingly, the consumer interface 304 may provide a wide range of information in addition to seller bids, for example, based on a user request for a response, the consumer interface 304 may display a quality index or value index for a retail item. Sales trends, reviews of seller products, seller customer service, consumer reports or fashion reports, seasonal price differences, etc., may provide a consumer with valuable information the consumer may use in addition to pricing and availability or delivery options. Also, for example, based on a user's geolocation, a targeted advertisement may be provided to a consumer. Also, the consumer interface 304 may provide an invitation to stop in a particular retailer and/or request bids for items the retailer sells. For example, a consumer may be eating lunch at a food court in a mall, and a retailer located next to the food court may determine that the consumer is located in the food court, and invite the consumer to visit the store and request bids for items, which the retailer may be willing to provide exclusive discounts for the consumer, which are not available through regular sales or coupons. Moreover, the consumer interface 304 may provide a wide variety of useful information to a consumer while shopping, which may allow the consumer to make an optimal decision. Further, for example, a lower price from another store may also provide a negotiating tool for consumers that want to haggle with a manager of the store they are presently shopping in.

In an example embodiment, a seller interface 306 may provide a user 114, such as a retailer employee, with bid requests and a variety of information relating to the current sales market. The seller interface 306 allows a seller to interact with geolocation based bidding information processing system 302 for providing bids to sell goods and services, such as retail items. For example, the seller interface receives a bid request from the geolocation based bidding information processing system 302, after a consumer sends a bid request for a sweater, and the sales identification processor 314 determines the specific sweater, for example, based on reading a UPC bar code from a consumer's picture. For example, the sales identification processor 314 may provide the specific sweater and comparable sweater inventory information received from database system 310, in the bid request to the seller interface 306. In an example embodiment, the seller interface 306 may be used by a retailer (e.g., retail store manager) and/or a party designated to make bids or interact on behalf of a retailer (e.g., marketing service, distributor, manufacturer). For example, a store manager may actively respond to each individual bid request in real-time when the seller interface indicates a bid request has been received. Also, for example, a store manager may set a predetermined bid parameter, such as a set percentage discount from the retail price of the requested item (e.g., 25% discount). Similarly, the seller interface may allow a store manager to set a predetermined bid price for each item, which the store manager may be able to change based on in-store inventory, purchasing trends, sales targets, and the like. Also, the seller interface 306 may allow for an extra discount, by way of percentage or dollar amount, to be set for consumers that would be new customers to the store. Information such as predetermined bid prices, inventory catalogs, current in-store inventory levels, etc., may be stored in database system 310. The store manager may authorize bids on items which are currently not in stock in a store, or are not typically carried in store, for example, by authorizing a distributor to confirm availability of an item within a certain timeframe. Accordingly, a distributor, manufacturer, or other related party may input information into the seller interface 306 which may be used to place a bid. Moreover, any appropriate party involved in the sales of goods or services may be a user 114 of the seller interface 306.

In an example embodiment, the seller interface 306 may be provided on a mobile device 103. Accordingly, a user 114 of the seller interface 306 may be able to handle bid requests in real-time, so consumers may quickly receive the seller's bid. Further, in an example embodiment, retail items with a retail price below a specified level (e.g., $200) are automatically generated for a seller based on predetermined price levels, and retail items above the specified level are provided for the store manager to set or approve in real-time. Accordingly, a store manager may be able allocate as much or as little time actively preparing bids as is reasonable and desirable. It should be appreciated that a small privately owned business and a large chain may have different needs and approaches to placing bids, and the seller interface 306 may accommodate a wide variety of styles for responding to bid requests. For example, certain predetermined bid pricing may be determined at a national or regional level, rather than each store location determining prices. In an example embodiment, the seller interface 306 may allow sellers to provide bid prices in dollar amounts, difference in dollar amount (e.g., $50 less than suggested retail price, $20 less than consumer's requested product, $10 above cost), and/or in percentages (e.g., 30% below suggested retail price, 5% above cost, 10% below competitor cost).

Also, new inventory information may be entered into the geolocation based bidding information processing system 302 by a store manager through the seller interface 306. For example, if a new product will be carried in the store, the UPC or SKU may be added to the list of items the store carries, so that when a request for that item is made, that store location will be identified for placing a bid. Similarly, if a new store location is opening up, the data relating to that store (e.g., street address, in-store inventory catalog) may be entered via the seller interface 306. Also, for example, when items are sold at a retailer, the current in-store inventory levels may be automatically maintained via the seller interface 306, so that the seller interface 306 may provide current inventory information with bid requests for consideration by the seller.

Accordingly, for example, a store manager may receive a bid request on the seller interface 306 which indicates the item requested by a consumer, the existing price of the item, the in-store inventory level of that item, the turn over rate of the item, the retail price, the item cost, regular sale pricing, a customer status and rating, and a recommended bid price. For example, the recommendation engine 312 may determine a recommended bid price based on recent and current sales of the item at multiple different retailers, the profit margin of that particular item, the particular consumer requesting the bid, etc. For example, a particular sweater the customer is interested in and priced at $50 in a competing retailer may have a retail price of $60, a cost of $30, and a regular sale price for the retailer of $40, the turn over rate for the sweater may be relatively low, the current in-store inventory may be high, and the customer may be an existing high value customer, so the recommended bid price may be $35. For example, if the customer is a new customer, the recommended bid price may instead be $20. Accordingly, the seller interface may advantageously allow the seller to use the consumer's purchase history and status as a repeat customer or new customer to determine a bid price. The cost of acquiring new customers through typical advertising channels may be significantly higher than the price of an aggressively priced bid, even if the bid may be selling an item at a loss. For example, marketing data may show that obtaining new customers through commercial advertising may cost $150 per customer, so pricing a bid $10 or $20 less may be a great way to bring a new customer to a store. Similarly, for example, if an existing customer has a purchase history of typically buying five to ten clothing items per visit, selling one sweater at a loss may still be highly profitable and may build store loyalty if the customer knows they are getting a great deal. Many consumers, once in the door of a retailer, will purchase items other than a discounted item they originally entered the store for, and often at a significantly higher profit margin than the discounted item.

The seller interface 306 may provide various other information in the form of reports or analytics, including information relating to in-store inventory, warehouse inventory, lead times, turnover rates, shipping costs, store sales targets, sales incentives, customer purchase trends, marketing data, etc. A seller may input information into seller interface 306 relating to sales data, including current pricing offered, special sales offers, actual transaction data, inventory data, etc. In an example embodiment, the seller may provide information through seller interface 306 which will be used by geolocation based bidding information processing system 302 to prepare reports or recommendations to consumers and/or other sellers. For example, each seller which has an account with the geolocation based bidding information processing system 302 may receive sales information on competitors in aggregate reports, while their sales information is in turn provided to their competitors. Accordingly, the geolocation based bidding information processing system 302 may provide valuable insights and recommendations to sellers that use the geolocation based bidding information processing system 302.

It should be appreciated that the users 114 of the geolocation based bidding information processing system 302, including consumers and sellers, may be required to agree to and/or execute a terms of use agreement or terms of service agreement and/or open an account. Various forms of enforcing the agreement may be implemented, including a transaction deposit policy, which may require a deposit or a credit card hold, or the like, and a standard schedule of fees or default payment schedule for infractions such as improper condition of an item, delay in delivery, etc. Accordingly, all parties may be protected from another party breaching the agreement.

It should be appreciated that certain functions described as performed, for example, at geolocation based bidding information processing system 302, may instead be performed locally at consumer interface 304 and seller interface 306, or vice versa. Further, in certain cases, tasks may be performed using consumer interface 304 and seller interface 306 or, for example, performed in person, such as a consumer purchasing a retail item at a retail location rather than accepting a bid via the consumer interface 304. It should be appreciated that the consumer interface 304 and seller interface 306 may be implemented, for example, in a web browser using an HTML file received from the geolocation based bidding information processing system 302. In an example embodiment, the consumer interface 304 and the seller interface 306 may be located on a website, and may further be implemented as a secure website. Also, the consumer interface 304 and the seller interface 306 may require a local application, for example, which a seller may pay for to have access to, for example, information from the geolocation based bidding information processing system 302 including requests for bids from consumers.

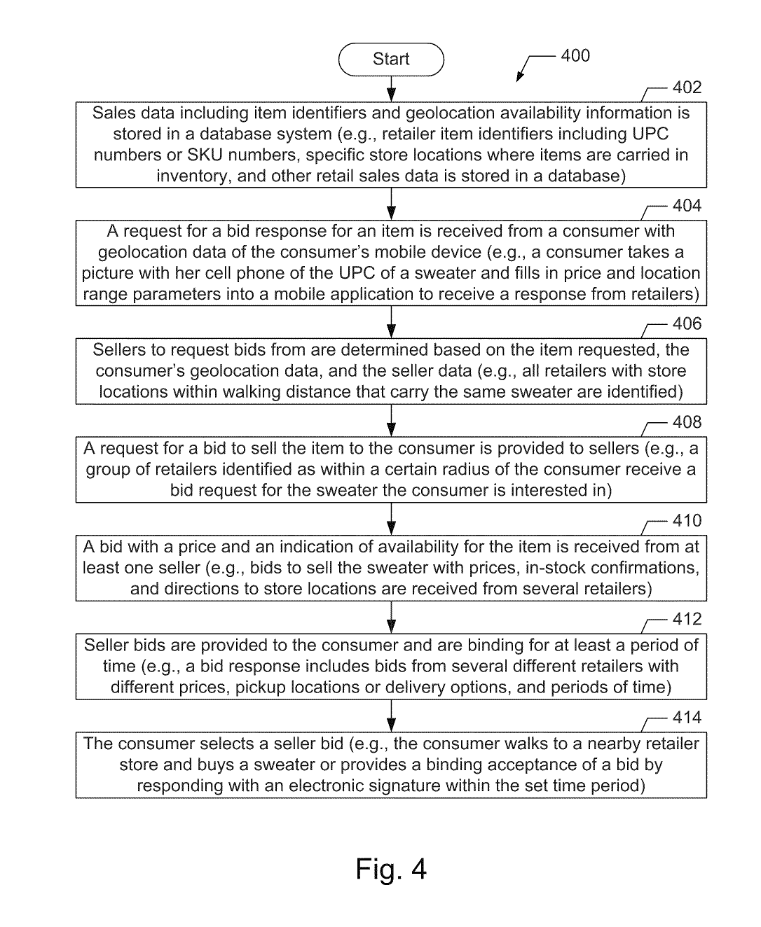

FIG. 4 is a flowchart of an example process 400 for geolocation based bidding. Although the process 400 is described with reference to the flowchart illustrated in FIG. 4, it will be appreciated that many other methods of performing the acts associated with the process 400 may be used. For example, the order of many of the blocks may be changed, certain blocks may be combined with other blocks, and many of the blocks described are optional.

The example process 400 for geolocation based bidding may allow users 114, including sellers and consumers, to efficiently sell and purchase goods and services, respectively. The example process 400 may begin with sales data including item identifiers and geolocation availability information is stored in a database system (block 402). For example, retailer item identifiers including UPC numbers or SKU numbers, specific store locations where items are carried in inventory, and other retail sales data is stored in a database. For example, sales data may be specific to sellers or retailers, such as inventory catalogs, current in-store inventory levels, or generic to all sellers of an item, such as retail pricing, average sale price, etc. For example a retail chain may carry different inventory at different locations, so the catalog of inventory specific to each geographical location may be maintained so that locations that never carry an item may not be asked for a bid to sell the item. It should be appreciated that if an item is not carried at a location, it may still be ordered for delivery, which may be indicated in the inventory data. Further, for example, geolocation availability information may be limited to delivery for a particular seller, such as an online retailer. In such case, the data relating to delivery times for various locations may be maintained for consumer requirements with time constraints for delivery. The database system 310 may include all the data used by the geolocation based bidding information processing system 302 for receiving requests for responses, providing requests for bids to sellers including geolocation information and related information, receiving information from sellers, such as inventory information and other sales information, and organizing bids for bid responses to consumers, and providing related information such as recommendations to consumers.

The example process 400 continues when a request for a bid response for an item is received from a consumer with geolocation data of the consumer's mobile device (block 404). For example, a consumer takes a picture with her cell phone of the UPC of a sweater and may fill in price and location range parameters into a mobile application to receive a response from retailers. The picture may be decoded within the user's mobile device or may be sent to the geolocation based bidding information processing system 302 for processing by the sales identification processor 314. Also, for example, written text may be processed using optical character recognition to provide information identifying an item such as a written UPC number, a written description, price information, or the like. Also, the request for a bid response includes geolocation data, such as GPS coordinates of the mobile phone, to identify the consumer's present location with respect to sellers that may provide bids. Further, a user may provide automatic bid acceptance requirements that, when met by a seller, the user will be bound to make the purchase.

In an example embodiment, the consumer may set a price requirement to provide to the sellers, which if not met, the bid will be automatically rejected, and if met by only one seller will be automatically accepted. Also, if multiple sellers meet the price requirement, the lowest price offered may be automatically accepted. A price requirement may be set as a dollar amount or a percentage discount from the price of the item at hand. For example, a consumer may take a picture of a UPC of a laptop computer and set a price requirement of $800 with an automatic acceptance of the lowest bid under $800 for delivery to the consumer's home or pick up within ten miles of the user's home. Also, for example, the consumer may set the bidding style, such as blind bidding, with retailers making their best bid without knowing the other retailers' bids, or open bidding, with retailers actively bidding and outbidding other retailers. Also, in an example embodiment, if a consumer repeatedly requests bids with frivolous price requirements (e.g., requesting a television for $5), the consumer request may be rejected, the consumer may be excluded from future participation, and the consumer account may be terminated.

Then, a list of sellers to request bids from are determined based on the item requested, the consumer's geolocation data, and the seller data (block 406). For example, all retailers with store locations within walking distance that carry the same sweater are identified. The geolocation based bidding information processing system 302 uses the geolocation of the consumer and the geolocation availability information for the item in question to determine which sellers may provide a qualifying bid. It should be appreciated that the retail store the consumer is presently located in may be identified as a seller that should receive a bid request. Accordingly, users of the geolocation based bidding information processing system 302 may receive lower prices without even leaving the store they are shopping in.

A request for a bid to sell the item to the consumer is provided to sellers (block 408). For example, a group of retailers identified as within a certain radius of the consumer receive a bid request for the sweater the consumer is interested in. For example, a walking distance radius may limit stores to a shopping mall the consumer is in, and several anchor retailers in the mall may carry the sweater the consumer wants, and thus, qualify to receive a bid request. Also, for example, if the consumer does not need the sweater on the same day, bids may be requested from retailers located further away and capable of delivering the sweater and online retailers that do not have a brick and mortar store location. The request for the bid that the seller receives may include a wide variety of data to help the seller place a competitive bid. As discussed above, various inventory data, sales trends, profit margin data, etc., may be provided for the seller to consider in placing a bid. Also, for example, a request for a bid may be sent to a retailer which carries an item, but may currently by out of stock in the store, because the inventory data may be incorrect, a delivery may be imminent, or the retailer may wish to place an inventoryless bid. As discussed above, a distributor or manufacturer may be able to confirm availability for an on-time delivery. Also, in an example embodiment, the bid request may ask retailers for their lowest bid or let sellers know that their bid will only be provided if it is less than a certain amount. For example, a retailer asked for its best bit on a television may say $1,699 if no specific price is required. However, if a consumer requires a bid price of $1,675 or less and agrees to automatically accept the bid, or the lowest of multiple bids meeting the requirement, the retailer may meet that price even though they would have provided a “lowest” price of $1,699. For example, a bid request may or may not inform the retailer that there is an automatic bid acceptance in place, and may or may not inform the retailer of consumer price requirements.

A bid with a price and an indication of availability for the item is received from at least one seller (block 410). For example, bids to sell the sweater with prices, in-stock confirmations, and directions to store locations are received from several retailers. Retailers which receive a request for bids may respond or may not respond, for example, if the current price is lower than the retailer would be willing to bid, or if the retailer does not currently have the item in stock. Also, the bids may be automatically made based on setting of predetermined bids in the seller interface 306, as discussed above. Further, bid pricing may depend on whether there is a consumer requirement. For example, if a consumer requirement is within 3% or $50 of a predetermined bid price, the retailer may meet the lower consumer requirement. The retailer may be asked to confirm availability of a certain level of inventory prior to providing a bid to avoid an error in inventory level or a last item being purchased prior to a consumer arriving to buy the item. Also, the retailers may set time limits for the bids based on the value of the item, the proximity of the consumer to the store, the current inventory level, etc. For example, if a store is placing a bid and the consumer is only in the neighboring store, which is a five minute walk, the time period may be relatively short. On the other hand, if the seller placing the bid is located several miles away, the seller may need to make the bid binding for several hours or days, so give the consumer a chance to make the trip. Also, for example, if only a single item remains in inventory, the bid may expire quickly, whereas, if there is abundant inventory and no worry of running out, the bid may not expire for a while.

As discussed above, sellers may take a wide variety of information into account in making a bid, including if the consumer is known to spend significant amounts of money once in the store or if the consumer would be a new customer. This type of information may be very useful in placing a bid. Many retailers may already track and analyze consumer behavior, so the geolocation based bidding information processing system 302 may allow the retailer to capitalize on that information by allowing the retailer to make bids that may even lose money on a sale, but save even more money in traditional marketing costs. For example, a retailer may decrease their budget for traditional advertisements and bring in more new customers into the store, thus, saving money using the geolocation based bidding information processing system 302 while increasing its customer base. It should be appreciated that typical advertising is provided to people that may not be receptive to an ad, but consumers requesting bids will be receptive to bids, particularly if they are aggressive bids. Typically, the consumer requesting the bid will not be a window shopper or looky-loo, like many people that receive normal advertising, but rather, the consumers requesting bids are typically serious buyers that have taken the initiative to go shopping for the item in question. Accordingly, the money a seller spends on aggressive bids may be used in a far more efficient manner than money spent on alternative advertising or marketing campaigns. Also, in an example embodiment, if a seller provides frivolous bids (e.g., overpriced items, improper items, or improper pick up location or timing), the bids may be automatically rejected, may not be provided to the consumer, the seller may be excluded from future participation, and the seller account may be terminated.

Next, the seller bids are provided to the consumer and are binding for at least a period of time (block 412). For example, a bid response includes bids from several different retailers with different prices, pickup locations or delivery options, and periods of time. As discussed above, the bids in the bid response may be formatted for ease of use and organized according to the consumer's preference in the consumer interface 304. The interface generation unit 316 may organize the bids by default and allow the consumer to organize or search through the bids. For example, the top bids may be from a store located across the shopping mall for $125 within the hour and a home delivery within two days for $115, which must be accepted via the mobile device within the next five minutes. Also, for example, a bid may have a low price of $85, but take three to four weeks to ship from an overstocked warehouse in another country. A delivery bid may be placed for a product in shipment to a retail location, which can be diverted and shipped directly to the consumer upon acceptance of the bid.

In an example embodiment, a seller bid which meets the user's automatic bid acceptance requirements may be provided in a bid response, and indicate that the consumer's account is being debited for the bid price and provide the delivery or availability information. It should be appreciated that if multiple sellers met the automatic bid acceptance requirements, the best offer may be automatically selected or the user may be allowed to select one or both bids. Further, seller bids may include a limit to the number of items, or may allow an unlimited number of items at the discounted bid price.

The consumer selects a seller bid (block 414). For example, the consumer walks to a nearby retailer store and buys a sweater or provides a binding acceptance of a bid by responding with an electronic signature within the set time period. The consumer interface 304 showing a retailer bid may be taken to the retailer, for example, reviewed by an employee or scanned to confirm that the consumer did in fact receive the bid as the consumer claims, much like a coupon is treated at a cash register. Also, a consumer may perform an electronic acceptance, for either a delivery purchase or an in-store purchase. For example, a consumer may not be able to get to the store in time before the bid expires, so the user may electronically purchase the item, in which case, the retailer may take hold the item in lay away, or the like to ensure the consumer receives the item upon arrival to pick it up. In an example embodiment, a consumer's identity may be verified by checking an identification card, credit card, or any other suitable means. For example, for an online purchase, a national internet ID or a biometric device such as a retinal scan may be used to verify the consumer's identity.

Accordingly, it should be appreciated that consumers and sellers may receive significant benefits from the method of geolocation based bidding disclosed herein. For example, price setting, inventory management, and marketing and advertising spending, may be greatly improved for sellers by utilizing the disclosed system and method. Consumers may benefit from more competitive pricing, piece of mind knowing that a fair price is being offered for prospective purchases, and improved availability and delivery options that allow the consumer to weigh the benefits and drawbacks of different availability or delivery options, pricing, and other variables. In an example embodiment, consumers can view recent prices paid for comparable retail items in specific locations and receive a recommendation to purchase from the geolocation based bidding information processing system 302. Similarly, sellers may be able to view all consumer bid requests and requirements, seller bids, sales results, etc. It should be appreciated, that certain information may be provided to consumers and/or sellers for free, or for a charge. Moreover, various inefficiencies in the sales industry may be minimized utilizing the presently disclosed system and method.

It should be appreciated that the presently disclosed system and method may be used in a wide variety of environments, and may be particularly beneficial to consumers at shopping malls, outlet malls, shopping districts, downtown areas, and the like. For example, a consumer may enjoy shopping and sight seeing at the Magnificent Mile while getting great deals on clothes, handbags, perfume, and jewelry by using the presently disclosed geolocation based bidding information processing system 302. In an example embodiment, a consumer buying a home theater system may obtain bids for the installation of the home theater system using the geolocation based bidding information processing system 302. Similarly, the presently disclosed system and method may apply to small or large purchases. For example, a consumer that is purchasing a $20,000 home theater system and a consumer purchasing a $10 bucket of paint may both benefit by saving money. Similarly, sellers of home theater systems and sellers of buckets of paint may both receive benefits alike. Further, the presently disclosed system may provide global flexibility based on consumer demand, product supply, currency exchange fluctuations, etc. For example, a consumer may want to purchase a dress at a retailer in New York, while a retailer in Paris, France, may be overstocked with that dress, which may bid a lower price, even including international shipping costs, than the same dress in New York, particularly if the dress is a higher priced item. Moreover, sellers may more efficiently use marketing funds and fully leverage data in their supply chain from manufacturing and production to global inventory management and shipping options.

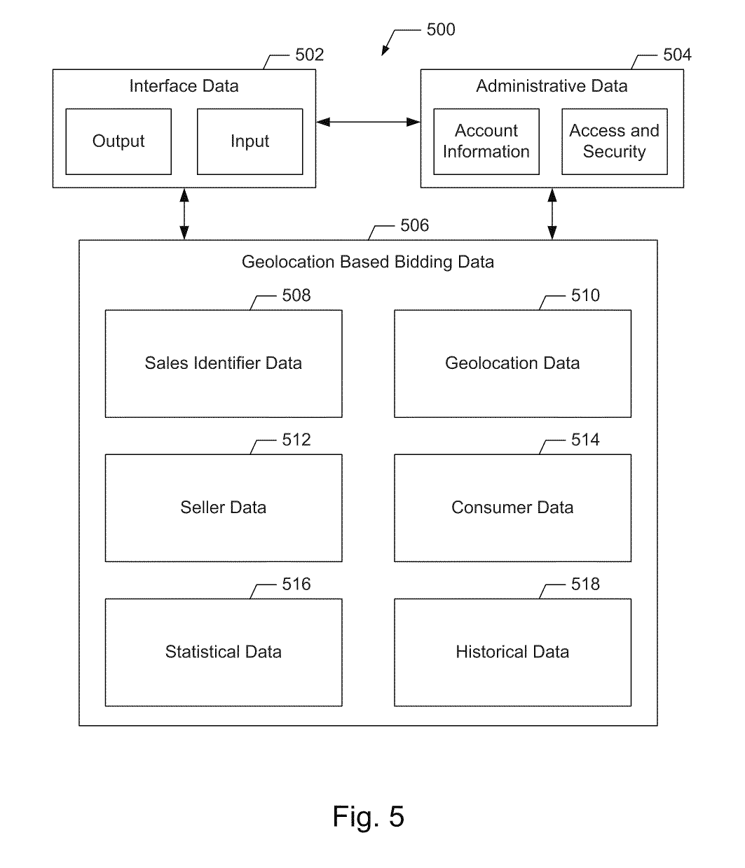

FIG. 5 illustrates a block diagram of an example data architecture 500. In the example data architecture 500, interface data 502, administrative data 504, and geolocation based bidding data 506 interact with each other, for example, based on user requests or commands. The interface data 502, administrative data 504, and geolocation based bidding data 506 may be stored on any suitable storage medium (e.g., server 226). It should be appreciated that different types of data may use different data formats, storage mechanisms, etc. Further, various applications may be associated with processing interface data 502, administrative data 504, and geolocation based bidding data 506. Various other or different types of data may be included in the example data architecture 500.

Interface data 502 may include input and output data of various kinds. For example, input data may include image capture data, barcode scanning data, mouse click data, scrolling data, hover data, keyboard data, touch screen data, speech recognition data, voice recognition data, etc., while output data may include image data, text data, video data, audio data, etc. Interface data 502 may include formatting, user interface options, links or access to other websites or applications, and the like. Interface data 502 may include applications used to provide or monitor interface activities and handle input and output data.

Administrative data 504 may include data and applications regarding user accounts. For example, administrative data 504 may include information used for updating accounts, such as creating or modifying seller accounts and/or consumer accounts. Further, administrative data 504 may include access data and/or security data. Administrative data 504 may include a terms of service agreement. Administrative data 504 may interact with interface data in various manners, providing a user interface 304, 306 with administrative features, such as implementing a user login and the like.

Geolocation based bidding data 506 may include, for example, sales identifier data 508, geolocation data 510, seller data 512, consumer data 514, statistical data 516, and/or historical data 518. Sales identifier data 508 may include UPC data, SKU data, barcode data, description data, option data, color data, price data, manufacturer data, distributor data, etc. Geolocation data 510 may include sales locations, GPS coordinates, mapping data, navigation data, etc. Seller data 512 may include seller catalog information, seller inventory information, seller locations, seller delivery information, seller pricing, seller profit margins, seller loyalty rates, brand loyalty, store loyalty, seller marketing information, etc. Consumer data 514 may include consumer account activity, consumer requests, consumer feedback, consumer loyalty, consumer spending habits, etc. Statistical data 516 may include information used for providing reports including graphs, forecasts, recommendations, customer value calculators, etc., including equations and other data used for statistical analysis. Historical data 508 may include past sales data, such as historical list prices, actual sale prices, profit margins, operating costs, service costs or profitability, loyalty information, etc. It should be appreciated that data may fall under multiple categories of geolocation based bidding data 506, or change with the passage of time. It should also be appreciated that geolocation based bidding data 506 may be tailored for a particular seller, for example, a retailer may request that a specific type of data that is not normally stored or used be stored in the database system 310. Accordingly, for example, customized reports may be provided to a seller interface 306 using that specific data for the retailer.

The integration of the various types of geolocation based bidding data 506 received from the consumer interface 304 and seller interface 306 may provide a synergistic and optimal resource for consumers and sellers alike. In an example embodiment, a consumer may benefit greatly from using an application in a mobile device 103 to receive both intrabrand information and interbrand information in real-time, based simply on taking a picture of a UPC or SKU. Sellers may be able to provide bids and information to the consumer in a manner that highlights the benefits of purchasing the product from the respective seller, such as lower pricing, nearby location, best customer service, etc. The intrabrand and interbrand information provided on a consumer interface 304 may allow the best product or service options for a particular consumer to be provided to that consumer, and may allow sellers to compete with other sellers taking into account a greater amount of sales information, resulting in a more efficient sales market.

As discussed above, a consumer that is requesting a bid is generally a serious buyer with adequate purchasing power rather than a window shopper or looky-loo, who is simply checking prices out of curiosity. The present system provides a new channel to reach targeted consumers that is far more efficient and focused that traditional advertising such as mass coupons, which are typically disregarded by consumers that are routinely bombarded with advertising offers. Moreover, for example, an in-store buyer may be far more valuable to a retailer than a random advertising recipient, because at that moment, the in-store buyer's purchase intent is greater than that of the general population. Analytics may allow retailers to determine the true dollar cost and the lifetime value of acquiring a new customer and maintaining an existing customer, and retailers may place bids accordingly for new and existing customers.

Accordingly, the presently disclosed system allows sellers to acquire new customers, maintain existing customers, and more efficiently use marketing and discount dollars using specific and/or generic consumer purchase data which may already be collected by the sellers. Use of such information may allow sellers to more efficiently match consumer demand and price elasticity with production, inventory, and shipping data.

Geolocation based bidding data 506 may be maintained in various servers 108, in databases or other files. It should be appreciated that, for example, a host device 104 may manipulate geolocation based bidding data 506 in accordance with the administrative data 504 and interface data 502 to provide requests or reports to users 114 including consumers and sellers and perform other associated tasks.

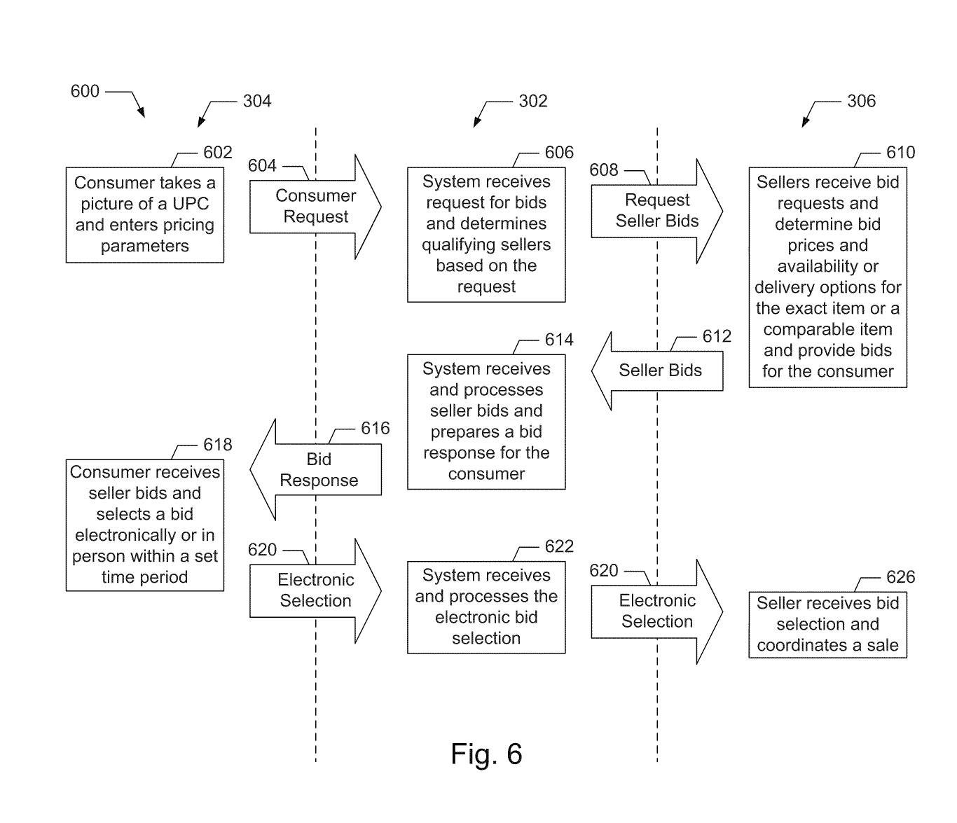

FIG. 6 is flow diagram illustrating an example process 600 for geolocation based bidding, according to an example embodiment of the present invention. Although the process 600 is described with reference to the flow diagram illustrated in FIG. 6, it will be appreciated that many other methods of performing the acts associated with the process 600 may be used. For example, the order of many of the blocks may be changed, certain blocks may be combined with other blocks, and many of the blocks described are optional.

In the example process 600, data may flow between the a consumer interface 304, the geolocation based bidding information processing system 302, and the seller interface 306, as discussed above based on consumer and seller interaction with the geolocation based bidding information processing system 302. It should be appreciated that the geolocation based bidding information processing system 302 may update the sales information stored in the database system 310 when purchase information is received from a consumer, a seller, or from any other information source. Accordingly, the sales information may remain current and/or provide sufficiently recent data for the benefit of consumers and sellers.

The example process 600 may begin with a consumer taking a picture of a UPC and entering price parameters into a consumer interface (block 602). Next, the consumer interface 304 sends to the consumer request, along with any pricing, location, options, or other parameters or requirements set by the user to the geolocation based bidding information processing system 302 (block 604). The geolocation based bidding information processing system 302 receives a request for bids from the consumer interface 304 and determines qualifying sellers based on the request (block 606). For example, only sellers that carry an appropriate item and are within a certain range from the consumer's geolocation and/or that can deliver an appropriate item to the consumer within a specific time period are determined as qualifying sellers. Then, the geolocation based bidding information processing system 302 requests seller bids from the seller interface 306 (block 608). The request sent to sellers may include a wide variety of information, about the consumer requirements or parameters and/or the sales market. Sellers receive bid requests and determine prices and availability or delivery options for the exact item or a comparable item and provide bids for the consumer (block 610). The seller bids are sent to the geolocation based bidding information processing system 302 from the seller interface 306 (block 612). The geolocation based bidding information processing system 302 receives and processes seller bids and prepares a bid response for the consumer (block 614). The geolocation based bidding information processing system 302 sends the bid response to the consumer interface 304 (block 616). It should be appreciated that a bid response may be sent only after waiting for a period of time or a certain number of seller bids, or a bid response may be sent with each seller bid that is received in real-time, which may continuously update the bid response. The consumer receives the bid response with one or more seller bids and selects a bid electronically or in person within a set time period (block 618). For example, if the consumer accepts a bid electronically, an electronic selection is sent from the consumer interface 304 to the geolocation based bidding information processing system 302 (block 620). The geolocation based bidding information processing system 302 receives and processes the electronic bid selection (block 622). Next, the electronic selection may be sent from the geolocation based bidding information processing system 302 to the seller interface 306 (block 624). The seller receives the bid selection and coordinates a sale (block 626). It should be appreciated that an electronic bid selection may trigger an item to be removed from a shelf, a lay away, a delivery order, an in transit shipping change, or the like, depending upon the delivery or pick up option selected by the consumer.

For exemplary purposes, the present disclosure discusses a various examples relating to a retail clothing purchase. However, it should be appreciated that the disclosed system, methods, and apparatus may be advantageously used in a non-retail setting including, for example, sales of goods and/or services.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
storing, on a computer readable medium, retailer data relating to sellers of retail items including at least retail item identifier information and retail item geolocation availability information;
receiving, via a consumer interface of a user mobile device, a first request for a bid response regarding a first retail item, wherein the user mobile device receives as an input, in response to a user action, machine readable data including an identifier of the first retail item, and the first request includes geolocation data of the user mobile device; and
causing at least one processing device to:
determine, based on the identifier of the first retail item, geolocation data, and the retailer data, at least one retailer to request a bid to sell the retail item for the bid response;
request, from the at least one retailer, the bid to sell the first retail item based on the first request;
receive at least one bid including at least a price and an indication of availability based on the first request; and
provide the bid response including the at least one bid via the consumer interface, the at least one bid being binding on the at least one retailer at least for a period of time.

2. The method of claim 1, wherein retail item identifier information for a first retailer includes a list of at least one of universal product codes and stock keeping units, and retail item geolocation availability information includes specific locations that retail items are sold at.

3. The method of claim 1, wherein the machine readable data is input into the user mobile device by at least one of capturing an image and scanning a barcode.

4. The method of claim 1, wherein the machine readable data includes at least one of text and barcode and the machine readable data is representative of at least one of a universal product code and a stock keeping unit.

5. The method of claim 1, wherein the at least one bid includes a first bid and a second bid.

6. The method of claim 5, wherein the first bid includes at least two bid options, with at least two of different prices, different in-store location availability, a home delivery option, different times of availability, and different color options.

7. The method of claim 1, further comprising:
receiving a consumer acceptance of a first bid, wherein the consumer acceptance is binding on the consumer.

8. The method of claim 7, wherein the consumer acceptance includes an electronic signature.

9. The method of claim 7, wherein the consumer acceptance includes a verification of a consumer identification, including at least one of a device ID, a national internet ID, and a biometric verification.

10. The method of claim 1, wherein the first request includes terms for automatic bid acceptance, and in response to a retailer bid meeting the terms for automatic bid acceptance, the consumer automatically accepts the seller bid.

11. The method of claim 10, wherein terms for automatic bid acceptance apply to a bid that meets a geographic range criteria and has the lowest price.

12. The method of claim 1, wherein the indication of availability includes a confirmation of availability of at least one identical retail item.

13. The method of claim 1, wherein the indication of availability includes a confirmation of availability of at least one similar retail item.

14. The method of claim 1, wherein the indication of availability includes a number of retail items currently in inventory in at least two locations.

15. The method of claim 1, wherein the indication of availability includes a delivery option for the first retail item including a delivery date.

16. The method of claim 1, wherein the period of time is at least one of one minute, five minutes, ten minutes, fifteen minutes, thirty minutes, one hour, two hours, six hours, one day, two days, three days, and one week.

17. The method of claim 1, wherein the geolocation data includes at least one of GPS coordinates, a WiFi connection location, a Bluetooth connection location, an IP address, a MAC address, RFID data, store identification data, street address data, latitude and longitude data, a zip code, a city, and a region.

18. The method of claim 1, wherein the geolocation data includes a confirmation of location entered by at least one of a user input of text, a user selection, and a location image capture, the confirmation of location including at least one of a store name, a mall name, a street name, a street address, a store logo, and a mall logo.

19. A method comprising:
storing, on a computer readable medium, sales data relating to sellers of at least one of goods and services, including at least sale geolocation availability information and at least one of item identifier information and service availability information;
receiving, via a consumer interface of a user mobile device, a first request for a bid response regarding at least one of a first item and a first service, wherein the user mobile device receives as an input, in response to a user action, machine readable data including an identifier of the at least one of the first item and the first service, and the first request includes geolocation data of the user mobile device; and
causing at least one processing device to:
determine, based on the identifier of the at least one of the first item and the first service, geolocation data, and the sales data, at least one seller to request a bid to sell the at least one of the first item and the first service for the bid response;
request, from the at least one seller, the bid to sell the at least one of the first item and the first service based on the first request;
receive at least one bid including at least a price and an indication of availability based on the first request; and
provide the bid response including the at least one bid via the consumer interface, the at least one bid being binding on the at least one seller at least for a period of time.

20. The method of claim 19, wherein the at least one seller includes a service provider.

21. The method of claim 19, wherein the at least one seller includes a goods provider.

22. A system comprising:
a computer readable medium storing retailer data relating to sellers of retail items including at least retail item identifier information and retail item geolocation availability information; and
at least one processing device operably coupled to the computer readable medium, the at least one processing device executing instructions to:
receive, via a consumer interface of a user mobile device, a first request for a bid response regarding a first retail item, wherein the user mobile device receives as an input, in response to a user action, machine readable data including an identifier of the first retail item, and the first request includes geolocation data of the user mobile device;
determine, based on the identifier of the first retail item, geolocation data, and the retailer data, at least one retailer to request a bid to sell the retail item for the bid response;
request, from the at least one retailer, the bid to sell the first retail item based on the first request;
receive at least one bid including at least a price and an indication of availability based on the first request; and
provide the bid response including the at least one bid via the consumer interface, the at least one bid being binding on the at least one retailer at least for a period of time.

23. A system comprising:
a computer readable medium storing sales data relating to sellers of at least one of goods and services, including at least sale geolocation availability information and at least one of item identifier information and service availability information; and
at least one processing device operably coupled to the computer readable medium, the at least one processing device executing instructions to:
receive, via a consumer interface of a user mobile device, a first request for a bid response regarding at least one of a first item and a first service, wherein the user mobile device receives as an input, in response to a user action, machine readable data including an identifier of the at least one of the first item and the first service, and the first request includes geolocation data of the user mobile device;
determine, based on the identifier of the at least one of the first item and the first service, geolocation data, and the sales data, at least one seller to request a bid to sell the at least one of the first item and the first service for the bid response;
request, from the at least one seller, the bid to sell the at least one of the first item and the first service based on the first request;
receive at least one bid including at least a price and an indication of availability based on the first request; and
provide the bid response including the at least one bid via the consumer interface, the at least one bid being binding on the at least one seller at least for a period of time.
